(19) United States
(12) Patent Application Publication
(10) Pub. No.: US 2009/0087822 A1
(43) Pub. Date: Apr. 2, 2009

(54) COMPUTER-BASED LANGUAGE TRAINING WORK PLAN CREATION WITH SPECIALIZED ENGLISH MATERIALS

(75) Inventors: Richard Stanton, Ottawa (CA); Rene Faucher, Carp (CA); Timon M. LeDain, Ottawa (CA)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(73) Assignee: NEUROLANGUAGE CORPORATION, Ottawa (CA)

(21) Appl. No.: 12/244,403

(22) Filed: Oct. 2, 2008

Related U.S. Application Data
(60) Provisional application No. 60/976,931, filed on Oct. 2, 2007.

(51) Int. Cl. G09B 19/00

(52) U.S. Cl. 434/156

(57) ABSTRACT

Language training for non-English proficient speakers is provided by an optimized language training work plan which enables a student to improve their effectiveness in working with specialized English language materials. Specialized English materials or authentic recordings/transcriptions of communication in the workplace is analyzed to determine its complexity against a recognized standard and generate a registry of skills. The measuring of the language complexity of authentic English materials allows work streams correlated to the statistical probability of a student achieving the desired level of proficiency to be developed in the generation of appropriate training content. Based upon an assessment of the students language skill level a work plan is created and applicable content is delivered to a content player through a network. The content provides the ability to improve various aspects of language fluency in relation to specialized content.

### CROSS-REFERENCE TO RELATED APPLICATIONS

This application claims priority from U.S. Patent Application No. 60/976,931 filed Oct. 2, 2007 which is herein incorporated by reference.

### TECHNICAL FIELD

The present invention relates to computer based language training and in particular to creating an optimized language training work plan for execution on a computing device using specialized English language materials.

### BACKGROUND

Language training directed to non-English proficient speakers generally uses content that is generic to facilitate learning and therefore there is no consideration for the specialized content that student will be dealing with relative to a specific job or task in a workplace. In work environments such as call centers, the ability to be proficient in English and in particular in English that is specialized or technical in nature is becoming of great importance. Current language training systems do not appropriately prepare students for an English work environment and the specialized language required at the completion of English language training and require additional training to be ready.

Most organizations who offer specialized language training offer a classroom model, or develop custom courseware to support the delivery of the materials. Often they are provided with a translated version (subtitles, non-English narration etc.), or attempt to model the typical interactions as student and teacher. As a result current approaches are extremely ineffective in terms of time required to go through the materials, or they are ineffective in developing specialized language skills suited to the language needs of the workplace.

Accordingly, systems and methods that enable language training with specialized English materials remains highly desirable.

### SUMMARY

Language training for non-English proficient speakers is provided by an optimized language training work plan which enables a student to improve their effectiveness in working with specialized English language materials. Specialized English materials or authentic recordings/transcriptions of communication in the workplace, is sampled and presented for analysis to determine its complexity against a recognized standard. The measuring of the language complexity of authentic English materials by using a recognized language scoring system allows work streams correlated to the statistical probability of a student achieving the desired level of proficiency to be developed. Three dimensional mastery criteria is used in the work plan to measure the effectiveness of the person's ability to progress from one skill to the next, including variance from the target speed of a native English person performing the task, overall speed of the language flow presented and accuracy at achieving the target score. Ranges for each criteria is defined allowing for an assessment of a person's proficiency against the benchmarks to be generated. This enables a determination of how much language training development would be required to take the student from their current proficiency to the target level for the specialized English requirement. Within each custom training model a work plan (software program) is delivered via the internet to improve various aspects of language fluency.

In accordance with the present disclosure there is provided a method of performing English language training of non-English proficient speakers using specialized English language content through a platform server, the method comprising: determining complexity criteria for training content and assigning the training content to one or more of a plurality of work streams, each work stream being associated with target learning metrics; determining a task complexity score by analyzing the specialized English language content and generating a registry of language skills for each of the plurality of work streams; and determining a proficiency score for a student using a standard language training scoring by providing testing material through a network to a content player; generating a work plan based upon the determined proficiency score mapped to one of the plurality of work streams and the associated registry of skills; and delivering training content through a network to a content player on a computing device, the training content is selected from the work plan from a mapping to a skill in the registry of skills.

In accordance with the present disclosure there is also provided a platform server for generating a English language training work plan, the system comprising: a processor; a memory comprising instructions for execution on the processor, the instructions comprising: determining complexity criteria for training content and assigning the training content to one or more of a plurality of work streams, each work stream being associated with target learning metrics; determining a task complexity score by analyzing the specialized English language content and generating a registry of language skills for each of the plurality of work streams; and determining a proficiency score for a student using a standard language training scoring by providing testing material through a network to a content player; generating a work plan based upon the determined proficiency score mapped to one of the plurality of work streams and the associated registry of skills; and delivering training content through a network to a content player, the training content is selected from the work plan from a mapping to a skill in the registry of skills.

In accordance with the present disclosure there is also provided a computer readable medium containing instructions for generating a English language training work plan, the instructions which when executed by a processor performing: determining complexity criteria for training content and assigning the training content to one or more of a plurality of work streams, each work stream being associated with target learning metrics; determining a task complexity score by analyzing the specialized English language content and generating a registry of language skills for each of the plurality of work streams; and determining a proficiency score for a student using a standard language training scoring by providing testing material through a network to a content player; generating a work plan based upon the determined proficiency score mapped to one of the plurality of work streams and the associated registry of skills; and delivering training content through a network to a content player, the training content is selected from the work plan from a mapping to a skill in the registry of skills.

### BRIEF DESCRIPTION OF THE DRAWINGS

Further features and advantages will become apparent from the following detailed description, taken in combination with the appended drawings, in which:

FIG. 1 is schematic representation of a system for internet based language training;

FIG. 2 is a block diagram of content module;

FIG. 3 is a method of content assessment;

FIG. 4 is a block diagram of a task module;

FIG. 5 is a method of performing task assessment;

FIG. 6 is a block diagram of assessment and training module;

FIG. 7 is a method of performing work plan creation and training; and

FIG. 8 is a method of is a block diagram of content player/viewer.

It will be noted that throughout the appended drawings, like features are identified by like reference numerals.

### DETAILED DESCRIPTION

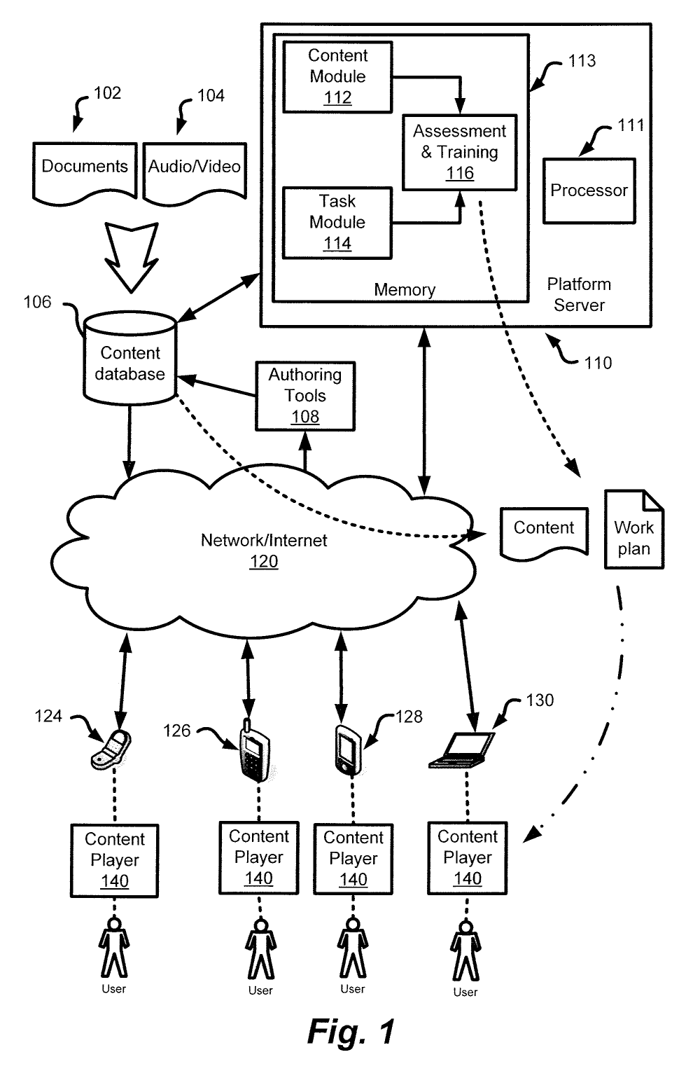

Embodiments are described below, by way of example only, with reference to FIGS. 1-8.

Language training for non-English proficient speakers is provided by an optimized language training work plan which enables a student to improve their effectiveness in working with specialized English language materials. The approach includes a configuration process, where actual specialized English materials (particular educational materials including science, History, Math; business materials, policy manuals etc.) or authentic recordings/transcriptions of communication in the workplace. The content is sampled and analyzed to determine its complexity against a recognized standard such as lexile, Fry's readability, Flesch/Flesch-Kincaid Readability Tests, European common framework etc. The measuring of the language complexity of the specialized or authentic English materials using a recognized language scoring system to allow work streams correlated to the statistical probability of a student achieving the desired level of proficiency to be developed. The comparison yields difficulty scores which can be used to identify ranges of language proficiency as benchmarks to manage the specialized English materials for the target non-English proficient.

The configuration process also provides for evaluating students for required content knowledge and for creating a series of custom training models based upon defined workstreams. This provides people of different language abilities opportunities to achieve the target level for the specialized English requirement. The training models are optimized to minimize the time required to achieve target proficiency. Three dimensional mastery criteria is used in the work plan to measure the effectiveness of the person's ability to progress from one skill to the next, including variance from the target speed of a native English person performing the task, and overall speed of the language flow presented and accuracy at achieving the target score.

Ranges for each criteria is defined allowing for an assessment of a person's proficiency against the benchmarks to be generated. This enables a determination of how much language training development would be required to take the student from their current proficiency to the target level for the specialized English requirement. Within each custom training model a work plan (software program) is delivered via a network such as the internet to a content player accessed by the student improve various aspects of language fluency.

The work plan includes various components designed to improve both subconscious language skills (phonemic awareness, phonological processing, decoding, phonics, word recognition, etc.) and higher-order language concepts (pronouncing words and phrases, listening comprehension, vocabulary development, model dialogues and authentic communication). The mix between the lower-order (LO) skills and the higher-order (HO) concepts are determined by an algorithm that factors the incoming ability range of the student, target achievement and time. Statistical measures are used to generate language training streams for students. The resulting work plan determines the amount of training between lower and higher order skills based on the students incoming score on an assessment, related how that score compares to target ranges of gains and based on a high statistical probability of achieving a target score.

The work plan in combination with authentic materials provides a highly effective way for a person who needs to improve their English with specialized materials. Rather then take extensive training courses in general English topics, a highly focused and user focused computer-based experience can be delivered. The task—analytic model ensures language development skills are delivered in an optimized, logical sequence, and that the goal of comprehension and oral speaking skills of the specialized language materials are well developed by the end of the work plan. Publishers of English content can deliver targeted training for those materials, for audiences who may have difficulty working in English.

Custom content and target vocabulary can be dynamically inserted into a standard database of content based on a task analysis of authentic English materials related to specific job or task requirements. The custom content adds to the corpus, allowing for growth of related training tasks that can be assigned to other users who access the system.

As shown in FIG. 1 a wide range of content is available through a private computer network or public network such the internet 120. The sources of content may be media sources such news sites or sites related to specific content topics or work related documents 102 in electronic format such as call or conversation transcriptions or audio/video 104 files. The files may be provided in any number of electronic video, audio or text formats. The content may be a single source or multiple sources, either freely accessible or provided on a subscription basis. Selected content is processed by authoring tools 108 which adapts the content to a format specific to facilitating language training by adding metadata such as transcription data, dictionary or context sensitive information. This content is then published to a content database 106. The platform server 110, comprises a processor 111 and memory 113. The platform server 110 indexes and categorizes the available content and can be utilized to develop work plan tailored to task related content and student ability. The content is indexed utilizing defined metadata criteria which identify the type of content, the difficultly level, the language skill tested by the content and is administered and advertised through the server. The content module 112 and task module 116 process content and task specific materials to generate work streams to achieve a target proficiency level. The assessment and training module 116 performs testing of a student to determine proficiency level and maps the student to a work stream based upon target skill for a content learning objective and delivers the appropriate content to the student. The server 110 and content 106 is accessed by the student through the internet 120 by a content player 140 resident on various computing devices such as mobile phone 124, smart phone 126, personal digital assistance 128, or personal computer or laptop 130. The content player 140 utilizes the created work plan to allow the student to select and interact with the appropriate content and guide language training of the student.

In the description the follow abbreviations are utilized:
(T) Target Score for a person to be proficient with a particular set of specialized materials
(H) Hours of training
(G) Average Gains per hour of training (using same units as Target Score)
(MG) Average Gain Expectation
(SDG)=Standard Deviation of Gains
(m) Minimum incoming Cut-score of Person starting work plan
(LO) Amount of Time spent on Lower Order Skills
(HO) Amount of Time spent on Higher Order Skills

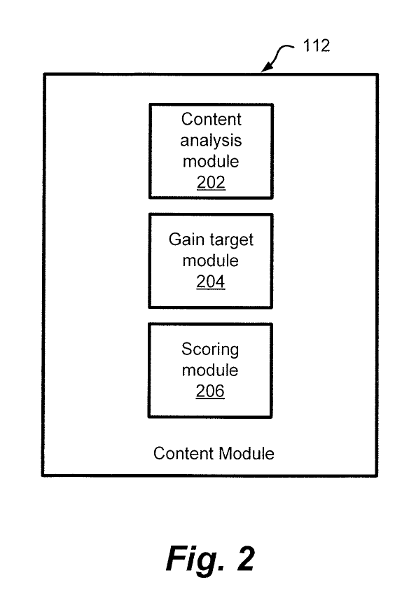

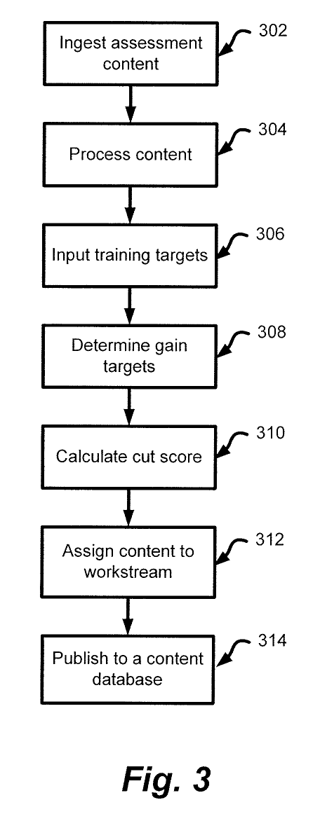

As shown in FIG. 2 and described in connection with the method of FIG. 3 the content module 112 is utilized for creating work plan parameters relative to the authentic or real-world training content such as video, news clips, audio tracks, text based publications etc. and to identify appropriate training content. The content selected is related to the target workplace environment either in subject matter or technical learning objectives. Authentic content is ingested into the platform server 100 at 302. Content analysis module 202 analyzes the authentic content using standard measures which measure complexity of content in a quantitative manner such as Lexile, Fry's Readability, and Practice Level. At 304 the content data is analyzed to produce row vector of content measures data set [a1, a2, . . . , an] and to calculate geometric mean is calculated in addition to the geometric standard deviation. A confidence interval at 95% is calculated and T set equal to Estimated Population Mean (Average difficulty of Content). At 306 input is provided to set Target for Max Training Hours (H), sample gains with students using generic set of training content and produce row Vector of gain measures data set [g1, g2, . . . , gn] and to calculate G. Gain targets can be calculated by gain target module 204 at 308 by calculating (H)×(G)=MG and Average Gain Expectation from allowed training period and calculating −1, −2, −3 SDG of set [g1, g2, . . . , gn]. Cut scores can then be calculated by scoring module 206 at 310 by T−[MG]=m to set Minimum Cut score for starting work plan (m).

The content can then be assigned to a work stream at 312 based upon the defined work stream learning metrics as shown in Table 1 based upon the content complexity and applicability to the work stream to develop a work plan. The training content is then published 314 to a content database 106 with metadata to identify content subject matter and language complexity criteria such as length, complexity, speed, applicable language skill such for low order and high order categories such as auditory processing words, word matching rhyming, word matching beginning, word matching ending, practice oral reading passages, practice listen & repeat, practice listen & answer, sight decoding letters, auditory processing letter names, ssa letters, pa sound matching beginning, ssa sound matching beginning, practice oral reading passages, practice listen & repeat, ssa sound matching ending, pa sound matching middle, practice oral reading passages, auditory processing letter sounds, ssa cv_vc, sight decoding cv_vc non words, sight decoding cvc non_words, sight decoding cvc words, pa blending 3 phonemes, ssa blending 3 phonemes options text or any other language skill category as discussed below. The language skill may in turn determine the type of content, for example listening skill will require audio or video content, while oral reading would utilized text based content.

TABLE 1

| | | | Work Stream 1 |
|---|---|---|---|
| | Work Stream 3 | Work Stream 2 | −1SDG to T or |
| | −3SDG to −2SDG | −2SDG to −1SDG | higher |
| Length of | Calculate Mid | Calculate Mid | Calculate Mid |
| Work | point/G = (H₃) for | point/G = (H₂) for | point/G = (H₁) |
| Stream | Work Stream 3 | Work Stream 2 | for Work Stream |
| | | | 1 |
| LO | 50% (H₃) | 30% (H₂) | 20% (H₁) |
| HO | 50% (H₃) | 70% (H₂) | 80% (H₁) |
| Low Score | m | >−2SDG | >−1SDG |
| High | <−2SDG | <−1SDG | >=T |
| Score | | | |
| Est. % of | 2.4% | 13.6% | 84% |
| Population | | | |

Within each custom training model, a range of required language skills is compiled and sequenced based on the task-analysis performed as part of the configuration process.

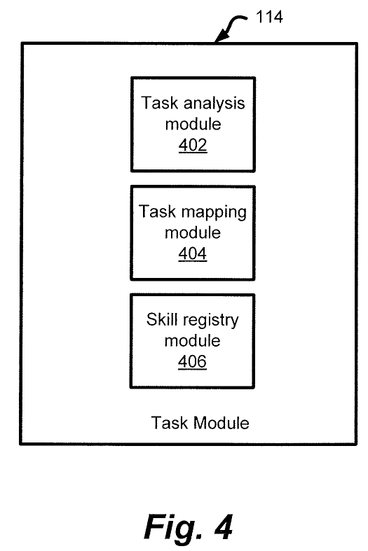

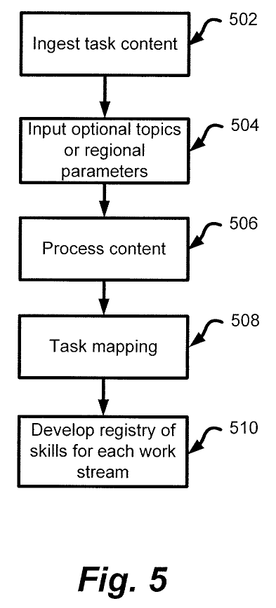

As shown in FIG. 4, and described in connection with the method of FIG. 5, the task assessment module 114 is utilized for assessing task specific content and mapping the task to specific content and the associated work stream. Content is ingested at 502. As part of the assessment, optional topics or regional parameters can be provided at 504 to the task assessment process. The task content is analyzed at 506 by task analysis module 402. Authentic recordings/transcriptions of communication in the workplace, such call center records or sample customer interaction conversations associate with a task or job function are processed by the task analysis module 402. A list of Lexical Items (compare to standard such as CELT) is developed and sorted for High frequency words & phrases in addition to determining Specialty Vocabulary for the job or task. The task mapping module 404 then compares processed content against existing content database at 508 to determine suitable content. In addition, content tasks are assigned with high correlation to ingested content. Specialty vocabulary and content examples can also be inserted into the appropriate units of the work plan. Work stream parameter rules are assigned and high priority language components defined. At 510 the registry of skills for each work stream is then developed to map to assessed content.

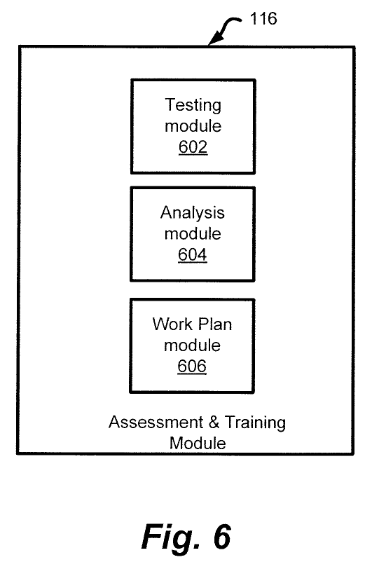

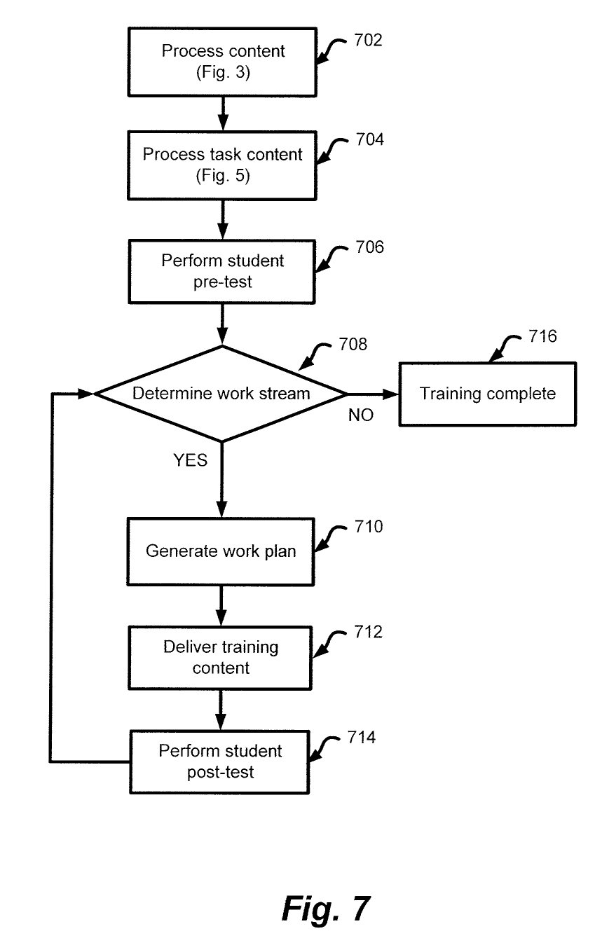

While the registry of tasks is static within each specific work stream, the person being trained experiences a unique experience going through the registry. This aspect is setup and managed in the assessment and training module 116 as shown in FIG. 6 and described in method diagram FIG. 7. This leads to a highly individualized training experience where every person focuses on those skills of particular difficulty to them.

One of the key design aspects of the assessment and training module 116 is the utilization of a three dimensional mastery criteria in the work plan for the purposes of measuring proficiency of a particular learning task. The three dimensions include: accuracy of performing the particular skill, variance from the target speed of a native English person performing the task, and overall speed of the language flow presented. The goal is to provide an accurate competency model to ensure the skills are developed to a point of automatic recognition and subconscious fluency i.e. doing without thinking.

FIG. 7 shows a method of performing work plan creation and student training. As noted above in connection with FIG. 3, content is processed and assigned to a work stream at 702. Task content is then processed as noted in connection with FIG. 5 to determine skills associated with each work stream at 704. A pre-test is performed by testing module 602 to measure the students language skill level at 706 through content player 140. The testing done by testing module 602 may use the same standardized measurement as in the content module 112 to provide a baseline. Content or specific language skill tests are provided to the student to determine the language skill level and proficiency scores. The test may be administered by the content server or alternatively, the testing may be performed by interaction directly with the content player 140 using standard content with the results being delivered to the work plan module 116. The testing data is analyzed at 708 by analysis module 604 to determine a score and determine if score falls within the ranges defined for a particular work stream such as for example work stream 1, 2 or 3. If the score falls within one the work stream parameters, YES at 708, the registry of skills developed for each work stream are assigned at 710 to the work plan generated by work plan module 606 which in turn maps by metadata or hyperlinks to stored processed content meeting the registry of skill complexity criteria. In addition to identifying processed authentic content, the work plan may identify inserted custom content database appropriate to the registry of skills. The custom content may be tailored by the company to provide product or task specific testing in addition to the custom content. The content is then delivered to the student 712 either by presenting a web portal for selection of content to be played in the content player or by pushing the content to the media player. Students can then work through each skill defined in the work plan using provided content in sequence to improve various aspects of language fluency. As skill level objectives are achieved new content is accessible ensuring mastery before proceeding to the next skill. Content that meets the work stream requirements as defined in the work plan by the registry of skilled can be accessed by the student. The content is played through the content player with the student interaction being analyzed by processing components such as voice recognition, as discussed below, to determine a score. Alternatively, the content player may provide feedback from the student directly to the content server for processing, in the form of raw text, speech files or video files for processing and scoring.

Factors for mastery include variance from the target speed of a native English person performing the task, and overall speed of the language flow presented and accuracy at achieving the target score. A post test is performed at 714 by the testing module 602 and the data results re-analyzed at step 708 to ensure target gain achieved and if a work stream and work plan must be generated. The goal of the post-testing is to have the student performing at the level of T (target content difficulty) or higher. If student score is less then T, the student is reassigned to the next most appropriate work-stream and the associated work plan. If the score is greater then T, NO at 708, training is completed at step 714 and no work stream is assigned.

A typical registry of skills for a specific for a work plan for a specific work stream would follow a logical flow from easier to more complex skills development exercises. The sequence, in one example, would follow the following sequence:

Example: Sample Work Stream 3 (50% of time on Lower-Order Skills/50% of time on Higher Order Skills) with a defined variance and speed.

PRACTICE ORAL READING PASSAGES PRE-TEST

This may determine if the user requires the full registry of skills or can advance to the higher-order skills
(LO) AUDITORY PROCESSING WORDS LEVEL 10 (Note this is a baseline skill)
Accuracy=90%, Variance=300 mS, Speed=1100 mS
(LO) WORD MATCHING RHYMING
Accuracy 85%, Variance=1000 mS, Speed=30 seconds
(LO) WORD MATCHING BEGINNING
Accuracy 85%, Variance=1000 mS, Speed=30 seconds
(LO) WORD MATCHING ENDING
Accuracy 85%, Variance=1000 mS, Speed=30 seconds
(HO) PRACTICE ORAL READING PASSAGES (Level 1) Note there may be Multiple Passages
Accuracy 85%, Variance 1000 mS, Speed=100-200 wpm
(HO) PRACTICE LISTEN & REPEAT (Level 1) Note there may be Multiple Passages
Accuracy 85%, Variance 1000 mS, Speed=100-200 wpm
(HO) PRACTICE LISTEN & ANSWER (Level 1) Note there may be Multiple Passages
Accuracy 85%, Variance 1000 mS, Speed=100-200 wpm
(LO) SIGHT DECODING LETTERS
Accuracy=96%, Variance=100 mS, Speed=900 mS
(LO) AUDITORY PROCESSING LETTER NAMES
Accuracy=96%, Variance=100 mS, Speed=1100 mS
(LO) SSA LETTERS
Accuracy 85%, Variance=1000 mS, Speed=30 seconds
(LO) PA SOUND MATCHING BEGINNING
Accuracy 85%, Variance=1000 mS, Speed=30 seconds
(LO) SSA SOUND MATCHING BEGINNING
Accuracy 85%, Variance=1000 mS, Speed=30 seconds
(HO) PRACTICE ORAL READING PASSAGES (Level 2) Note there may be Multiple Passages
Accuracy 85%, Variance 1000 mS, Speed=100-200 wpm
(HO) PRACTICE LISTEN & REPEAT (Level 2) Note there may be Multiple Passages
Accuracy 85%, Variance 1000 mS, Speed=100-200 wpm
(HO) PRACTICE LISTEN & ANSWER (Level 2) Note there may be Multiple Passages
Accuracy 85%, Variance 1000 mS, Speed=100-200 wpm
(LO) PA SOUND MATCHING ENDING
Accuracy 85%, Variance=1000 mS, Speed=30 seconds
(LO) SSA SOUND MATCHING ENDING
Accuracy 85%, Variance=1000 mS, Speed=30 seconds
(LO) PA SOUND MATCHING MIDDLE
Accuracy 85%, Variance=1000 mS, Speed=30 seconds
(LO) SSA SOUND MATCHING MIDDLE
Accuracy 85%, Variance=1000 mS, Speed=30 seconds
(HO) PRACTICE ORAL READING PASSAGES (Level 3) Note there may be Multiple Passages
Accuracy 85%, Variance 1000 mS, Speed=100-200 wpm
(HO) PRACTICE LISTEN & REPEAT (Level 3) Note there may be Multiple Passages
Accuracy 85%, Variance 1000 mS, Speed=100-200 wpm
(HO) PRACTICE LISTEN & ANSWER (Level 3) Note there may be Multiple Passages
Accuracy 85%, Variance 1000 mS, Speed=100-200 wpm
(LO) AUDITORY PROCESSING LETTER SOUNDS
Accuracy=96%, Variance=100 mS, Speed=1100 mS
(LO) SSA CV_VC GROUP 1
Accuracy 85%, Variance=1000 mS, Speed=30 seconds
(LO) SSA CV_VC GROUP 2
Accuracy 85%, Variance=1000 mS, Speed=30 seconds
(LO) SSA CV_VC GROUP_{—}3
Accuracy 85%, Variance=1000 mS, Speed=30 seconds
(LO) SIGHT DECODING CV_VC NON WORDS
Accuracy=96%, Variance=100 mS, Speed=900 mS
(LO) AUDITORY PROCESSING CV_VC NON WORDS
Accuracy=96%, Variance=100 mS, Speed=1100 mS
(HO) PRACTICE ORAL READING PASSAGES (Level 4) Note there may be Multiple Passages
Accuracy 85%, Variance 1000 mS, Speed=100-200 wpm
(HO) PRACTICE LISTEN & REPEAT (Level 4) Note there may be Multiple Passages
Accuracy 85%, Variance 1000 mS, Speed=100-200 wpm
(HO) PRACTICE LISTEN & ANSWER (Level 4) Note there may be Multiple Passages
Accuracy 85%, Variance 1000 mS, Speed=100-200 wpm
(LO) SIGHT DECODING CVC NON_WORDS
Accuracy=96%, Variance=100 mS, Speed=900 mS
(LO) SIGHT DECODING CVC WORDS
Accuracy=96%, Variance=100 mS, Speed=900 mS
(LO) PA BLENDING 3 PHONEMES
Accuracy 85%, Variance=1000 mS, Speed=30 seconds
(LO) SSA BLENDING 3 PHONEMES OPTIONS TEXT
Accuracy 85%, Variance=1000 mS, Speed=30 seconds
(LO) AUDITORY PROCESSING CVC NON WORDS
Accuracy=96%, Variance=100 mS, Speed=1100 mS
(LO) AUDITORY PROCESSING CVC WORDS
Accuracy=96%, Variance=100 mS, Speed=1100 mS
(LO) PA BLENDING 4 PHONEMES
Accuracy 85%, Variance=1000 mS, Speed=30 seconds
(LO) SIGHT DECODING CVCV NON WORDS
Accuracy=96%, Variance=100 mS, Speed=900 mS
(LO) SIGHT DECODING CVCV WORDS
Accuracy=96%, Variance=100 mS, Speed=900 mS
(LO) SSA BLENDING 4_PHONEMES_OPTIONS_TEXT
Accuracy 85%, Variance=1000 mS, Speed=30 seconds
(LO) AUDITORY PROCESSING CVCV NON_WORDS
Accuracy=96%, Variance=100 mS, Speed=1100 mS
(LO) AUDITORY PROCESSING CVCV WORDS
Accuracy=96%, Variance=100 mS, Speed=1100 mS
(HO) PRACTICE ORAL READING PASSAGES (Level 5) Note there may be Multiple Passages
Accuracy 85%, Variance 1000 mS, Speed=100-200 wpm
(HO) PRACTICE LISTEN & REPEAT (Level 5) Note there may be Multiple Passages
Accuracy 85%, Variance 1000 mS, Speed=100-200 wpm
(HO) PRACTICE LISTEN & ANSWER (Level 5) Note there may be Multiple Passages
Accuracy 85%, Variance 1000 mS, Speed=100-200 wpm
(LO) PA SEGMENTATION 3_PHONEMES
Accuracy 85%, Variance=1000 mS, Speed=30 seconds
(LO) SIGHT DECODING CCVC NON WORDS
Accuracy=96%, Variance=100 mS, Speed=900 mS
(LO) SIGHT DECODING CCVC WORDS
Accuracy=96%, Variance=100 mS, Speed=900 mS
(LO) AUDITORY PROCESSING CCVC NON WORDS
Accuracy=96%, Variance=100 mS, Speed=1100 mS
(LO) AUDITORY PROCESSING CCVC WORDS
Accuracy=96%, Variance=100 mS, Speed=1100 mS
(LO) SSA SEGMENTATION 3 PHONEMES
Accuracy 85%, Variance=1000 mS, Speed=30 seconds
(LO) SIGHT DECODING CVCC NON WORDS
Accuracy=96%, Variance=100 mS, Speed=900 mS
(LO) SIGHT DECODING CVCC WORDS
Accuracy=96%, Variance=100 mS, Speed=900 mS
(LO) AUDITORY PROCESSING CVCC NON WORDS
Accuracy=96%, Variance=100 mS, Speed=1100 mS
(LO) AUDITORY PROCESSING CVCC WORDS
Accuracy=96%, Variance=100 mS, Speed=1100 mS
(LO) SSA SEGMENTATION 3 PHONEMES OPTIONS TEXT
Accuracy 85%, Variance=1000 mS, Speed=30 seconds
(HO) PRACTICE ORAL READING PASSAGES (Level 6) Note there may be Multiple Passages
Accuracy 85%, Variance 1000 mS, Speed=100-200 wpm
(HO) PRACTICE LISTEN & REPEAT (Level 6) Note there may be Multiple Passages
Accuracy 85%, Variance 1000 mS, Speed=100-200 wpm
(HO) PRACTICE LISTEN & ANSWER (Level 6) Note there may be Multiple Passages
Accuracy 85%, Variance 1000 mS, Speed=100-200 wpm
(LO) SIGHT DECODING CVVC GROUP 1 NON WORDS
Accuracy=96%, Variance=100 mS, Speed=900 mS
(LO) SIGHT DECODING CVVC GROUP 1 WORDS
Accuracy=96%, Variance=100 mS, Speed=900 mS
(LO) AUDITORY PROCESSING CVVC GROUP 1 NON WORDS
Accuracy=96%, Variance=100 mS, Speed=1100 mS
(LO) AUDITORY PROCESSING CVVC GROUP 1 WORDS
Accuracy=96%, Variance=100 mS, Speed=1100 mS
(LO) PA SEGMENTATION 4 PHONEMES
Accuracy 85%, Variance=1000 mS, Speed=30 seconds
(LO) SIGHT DECODING CVVC GROUP 2 NON WORDS
Accuracy=96%, Variance=100 mS, Speed=900 mS
(LO) SIGHT DECODING CVVC GROUP 2 WORDS
Accuracy=96%, Variance=100 mS, Speed=900 mS
(LO) SSA SEGMENTATION 4 PHONEMES
Accuracy 85%, Variance=1000 mS, Speed=30 seconds
(LO) AUDITORY PROCESSING CVVC GROUP 2 NON WORDS
Accuracy=96%, Variance=100 mS, Speed=1100 mS
(LO) AUDITORY PROCESSING CVVC_GROUP_{—}2 WORDS
Accuracy=96%, Variance=100 mS, Speed=1100 mS
(LO) SSA SEGMENTATION 4_PHONEMES_OPTIONS_TEXT
Accuracy 85%, Variance=1000 mS, Speed=30 seconds
(HO) PRACTICE ORAL READING PASSAGES (Level 7) Note there may be Multiple Passages
Accuracy 85%, Variance 1000 mS, Speed=100-200 wpm
(HO) PRACTICE LISTEN & REPEAT (Level 7) Note there may be Multiple Passages
Accuracy 85%, Variance 1000 mS, Speed=100-200 wpm
(HO) PRACTICE LISTEN & ANSWER (Level 7) Note there may be Multiple Passages
Accuracy 85%, Variance 1000 mS, Speed=100-200 wpm
(LO) SIGHT DECODING WORDS LEVEL 1
Accuracy=96%, Variance=100 mS, Speed=900 mS
(LO) AUDITORY PROCESSING WORDS LEVEL 1
(LO) SIGHT DECODING WORDS LEVEL 2
Accuracy=96%, Variance=100 mS, Speed=900 mS
(LO) AUDITORY PROCESSING WORDS LEVEL 2
Accuracy=96%, Variance=100 mS, Speed=1100 mS
(LO) SIGHT DECODING WORDS LEVEL 3
Accuracy=96%, Variance=100 mS, Speed=900 mS
(LO) AUDITORY PROCESSING WORDS LEVEL 3
Accuracy=96%, Variance=100 mS, Speed=1100 mS
(LO) SIGHT DECODING WORDS LEVEL 4
Accuracy=96%, Variance=100 mS, Speed=900 mS
(LO) AUDITORY PROCESSING WORDS LEVEL 4
Accuracy=96%, Variance=100 mS, Speed=1100 mS
(LO) SIGHT DECODING WORDS LEVEL 5
Accuracy=96%, Variance=100 mS, Speed=900 mS
(LO) AUDITORY PROCESSING WORDS LEVEL 5
Accuracy=96%, Variance=100 mS, Speed=1100 mS
(LO) SIGHT DECODING WORDS LEVEL 6
Accuracy=96%, Variance=100 mS, Speed=900 mS
(LO) AUDITORY PROCESSING WORDS LEVEL 6
Accuracy=96%, Variance=100 mS, Speed=1100 mS
(LO) SIGHT DECODING WORDS LEVEL 7
Accuracy=96%, Variance=100 mS, Speed=900 mS
(LO) AUDITORY PROCESSING WORDS LEVEL 7
Accuracy=96%, Variance=100 mS, Speed=1100 mS
(LO) SIGHT DECODING WORDS LEVEL 8
Accuracy=96%, Variance=100 mS, Speed=900 mS
(LO) AUDITORY PROCESSING WORDS LEVEL 8
Accuracy=96%, Variance=100 mS, Speed=1100 mS
(HO) PRACTICE ORAL READING PASSAGES (Level 8) Note there may be Multiple Passages
Accuracy 85%, Variance 1000 mS, Speed=100-200 wpm
(HO) PRACTICE LISTEN & REPEAT (Level 8) Note there may be Multiple Passages
Accuracy 85%, Variance 1000 mS, Speed=100-200 wpm
(HO) PRACTICE LISTEN & ANSWER (Level 8) Note there may be Multiple Passages
Accuracy 85%, Variance 1000 mS, Speed=100-200 wpm
(LO) SIGHT DECODING WORDS LEVEL 9
Accuracy=96%, Variance=100 mS, Speed=900 mS
(LO) AUDITORY PROCESSING WORDS LEVEL 9
Accuracy=96%, Variance=100 mS, Speed=1100 mS
(HO) PRACTICE ORAL READING PASSAGES (Level 10) Note there may be Multiple Passages
Accuracy 85%, Variance 1000 mS, Speed=100-200 wpm
(HO) PRACTICE LISTEN & REPEAT (Level 10) Note there may be Multiple Passages
Accuracy 85%, Variance 1000 mS, Speed=100-200 wpm
(HO) PRACTICE LISTEN & ANSWER (Level 10) Note there may be Multiple Passages
Accuracy 85%, Variance 1000 mS, Speed=100-200 wpm
(LO) SIGHT DECODING WORDS LEVEL 10
Accuracy=96%, Variance=100 mS, Speed=900 mS
(LO) AUDITORY PROCESSING WORDS LEVEL 10
Accuracy=96%, Variance=100 mS, Speed=1100 mS
(LO) AUDITORY PROCESSING WORDS LEVEL 10
Accuracy=98%, Variance=100 mS, Speed=1100 mS
(LO) AUDITORY PROCESSING WORDS LEVEL 10 (Note this is a Post Test Skill to Measure Gains in Processing Efficiency—Target is Native English Language Processing Levels)
Accuracy=100%, Variance=100 mS, Speed=1100 mS
(HO) PRACTICE ORAL READING PASSAGES POST—TEST

Legend:

PA=Phonemic Awareness

SSA=Sound Symbol Awareness

C=Consonant

V=Vowel

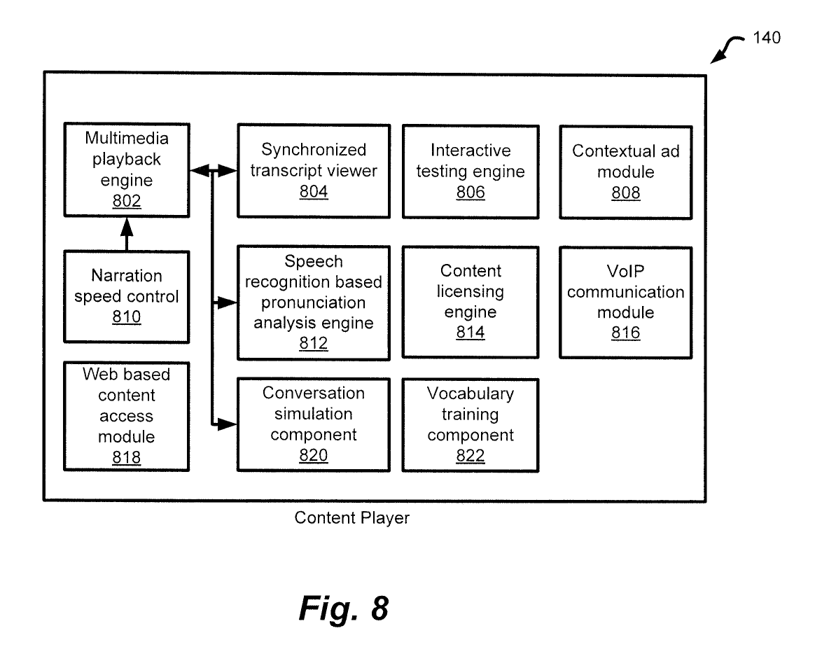

All of the tasks embodied in the work plans are presented to the target student through a content player that allows them to interact with the content in a multi-sensory way—reading, listening, speaking, comprehending. This process ensures the student masters the relevant specialized English content, and ensures the skills are developed in an optimized way. An unparalleled combination of learning efficiency and gains is provided in performing the specialized language tasks. FIG. 8 is a block diagram of the content player/viewer. The content player operating on a computing device provides a multimedia playback engine 802, synchronized transcript viewer 804, and interactive testing engine 806 for determining a skill level and for enabling interaction with content by using audio input for speech recognition. A contextual ad module 808 may be provided for delivering ads related to the content to the end user, narration speed control module 810 for adjusting the speed of audio content and speech recognition based pronunciation and analysis engine 812 to enable content interaction. A content licensing engine 814 may be supplied if content is subscription based and a voice-over-internet-protocol (VOIP) module 816 may be provided to facilitate interactive learning between students. A web based content access module 818 enables retrieval of content from the content database and a conversation simulation component 810 may be used to provide a virtual conversation and vocabulary training component 822. The criteria as defined in the work plan can be processed by the content player to determine if the student meets the criteria. For example the speech recognition based pronunciation and analysis engine 812 would be used to determine if the student is meeting the objective for Accuracy, Variance and Speed for the particular content. Alternatively, the content player may simply record the students interaction with the player and provided the raw data to the platform server for analysis such as speech recognition and for assessment analysis.

When a user is provided with the transcript of a narrated story, they may often have trouble following where they are in the text. This issue can be addressed by highlighting the current word or sentence being spoken in the audio track in the transcript text through visual cues which are provided through the synchronized transcript viewer.

When working with new content, users often encounter words or expressions that are unfamiliar to them. To improve their comprehension of the content and grow their vocabulary, the vocabulary training component allows them to quickly find definitions for unknown words or expressions in the language of the content itself, or their mother tongue. In addition intelligent definitions that are keyed to the word's part of speech as used in the content text are provided. If two or more words are part of a common term or expression, both words are highlighted and the expression that it refers to is described as opposed to simply the definitions of the individual words on their own.

The method steps may be embodied in sets of executable machine code stored in a variety of formats such as object code or source code. Such code is described generically herein as programming code, or a computer program for simplification. Clearly, the executable machine code or portions of the code may be integrated with the code of other programs, implemented as subroutines, plug-ins, add-ons, software agents, by external program calls, in firmware or by other techniques as known in the art.

The embodiments may be executed by a computer processor or similar device programmed in the manner of method steps, or may be executed by an electronic system which is provided with means for executing these steps. Similarly, a computer readable medium or electronic memory medium such computer diskettes, DVD or CD-ROMS, Random Access Memory (RAM), Read Only Memory (ROM) or similar computer software storage media known in the art, may be programmed to execute such method steps. As well, electronic signals representing these method steps may also be transmitted via a communication network.

The embodiments described above are intended to be illustrative only. The scope of the invention is therefore intended to be limited solely by the scope of the appended claims.

1. A method of performing English language training of non-English proficient speakers using specialized English language content through a platform server, the method comprising:
determining complexity criteria for training content and assigning the training content to one or more of a plurality of work streams, each work stream being associated with target learning metrics;
determining a task complexity score by analyzing the specialized English language content and generating a registry of language skills for each of the plurality of work streams; and
determining a proficiency score for a student using a standard language training scoring by providing testing material through a network to a content player;
generating a work plan based upon the determined proficiency score mapped to one of the plurality of work streams and the associated registry of skills; and
delivering training content through a network to a content player on a computing device, the training content is selected from the work plan from a mapping to a skill in the registry of skills.

2. The method of claim 1 wherein the registry of skills defines a plurality of language skills for each of the plurality of work streams, each being identified as low order or high order skill in addition to having an associated accuracy target, variance target and speed target for the student to achieve.

3. The method of claim 2 wherein the work plan the registry of skills associated with the particular work stream, and identifies training content from a content database which matches the language skill.

4. The method of claim 3 wherein the proficiency score and task complexity score are determined using a Lexile, Fry's Readability, or Practice Level score.

5. The method of claim 4 wherein the content is analyzed to produce row vector of content measures data set [a1, a2, . . . , an] of the of the training content.

6. The method of claim 5 wherein the complexity criteria is determined by analyzing content to calculate geometric mean of the training content.

7. The method of claim 6 wherein the complexity criteria is determined by analyzing training content to calculate geometric standard deviation gains (SDG) of the training content.

8. The method of claim 7 wherein complexity criteria is determined by analyzing content to calculate a confidence interval at 95% and set T=to Estimated Population Mean (Average difficulty of Content) of the training content.

9. The method of claim 8 further comprising generating a Target for Max Training Hours (H), sample gains with students using generic set of training content and produce row Vector of gain measures data set [g1, g2, . . . , gn] and to calculate G of the authentic content for each work stream.

10. The method of claim 9 further comprising the step of calculating gain targets by calculating (H)×(G)=MG for each work stream.

11. The method of claim 10 further comprising the step of calculating Average Gain Expectation from allowed training period and calculating −1, −2, −3 SDG of set [g1, g2, . . . , gn] for each work stream.

12. The method of claim 11 further comprising the step of calculating a cut score as defined by T−[MG]=m to set Minimum Cut score for starting work plan (m) for each work stream.

13. The method of claim 12 wherein a first works stream is defined by −1 SDG to T or higher, a second work stream is defined by −2 SDG to −1 SDG and a third work stream is defined by −3 SDG to −2 SDG.

14. A platform server for generating a English language training work plan, the system comprising:
a processor;
a memory comprising instructions for execution on the processor, the instructions comprising:
determining complexity criteria for training content and assigning the training content to one or more of a plurality of work streams, each work stream being associated with target learning metrics;
determining a task complexity score by analyzing the specialized English language content and generating a registry of language skills for each of the plurality of work streams; and
determining a proficiency score for a student using a standard language training scoring by providing testing material through a network to a content player;
generating a work plan based upon the determined proficiency score mapped to one of the plurality of work streams and the associated registry of skills; and
delivering training content through a network to a content player, the training content is selected from the work plan from a mapping to a skill in the registry of skills.

15. A computer readable medium containing instructions for generating a English language training work plan, the instructions which when executed by a processor performing:
determining complexity criteria for training content and assigning the training content to one or more of a plurality of work streams, each work stream being associated with target learning metrics;
determining a task complexity score by analyzing the specialized English language content and generating a registry of language skills for each of the plurality of work streams; and
determining a proficiency score for a student using a standard language training scoring by providing testing material through a network to a content player;
generating a work plan based upon the determined proficiency score mapped to one of the plurality of work streams and the associated registry of skills; and
delivering training content through a network to a content player, the training content is selected from the work plan from a mapping to a skill in the registry of skills.
